(19) United States
(12) Patent Application Publication
(10) Pub. No.: US 2026/0351963 A1
(43) Pub. Date: Nov. 5, 2026

(54) METHOD AND DEVICE FOR ADJUSTING THE POTENTIAL LEVEL OF DC CONDUCTORS

(71) Applicant: SMA Solar Technology AG, Niestetal (DE)

(72) Inventors: Alexander Unru, Baunatal (DE); Bernhard Voll, Lohfelden (DE); Michael Krug, Niestetal (DE)

(21) Appl. No.: 19/712,219

(22) Filed: Jun. 18, 2026

Related U.S. Application Data
(63) Continuation of application No. PCT/EP2024/085860, filed on Dec. 12, 2024.

(30) Foreign Application Priority Data
Dec. 18, 2023 (DE) 10 2023 135 591.0

(51) Int. Cl. H02J 1/06; C25B 9/65; H02J 1/16

(52) U.S. Cl. CPC H02J 1/06; C25B 9/65; H02J 1/16

(57) ABSTRACT

The application relates to a method and a device for adjusting the potential level of a first and a second DC conductor. The DC conductors are provided to supply an electrolyzer with electrical power and the electrical power is transmissible via a rectifier from an AC grid to the DC conductor. In a first operating mode the potential level of the first and second DC conductors is adjusted such that both DC conductors have the same polarity relative to ground potential. The application further relates to a DC grid having an electrolyzer, such a device and the first and second DC conductors.

### REFERENCE TO RELATED APPLICATIONS

This application is a Continuation of International Application number PCT/EP2024/085860, filed on Dec. 12, 2024, which claims the benefit of German Application number 10 2023 135 591.0, filed on Dec. 18, 2023. The contents of the above-referenced Patent Applications are hereby incorporated by reference in their entirety.

### FIELD

The application relates to a method and a device for adjusting the potential level of DC conductors (DC: direct current/direct voltage), and to a DC grid which includes such a device and an electrolyzer.

### BACKGROUND

Electrolyzers can be supplied with electrical DC power via DC connections to perform the electrolysis. The electrical DC power can be drawn from an AC grid and supplied to the electrolyzer via a rectifier and via DC conductors. The potential difference between the DC conductors corresponds to the DC voltage applied to the electrolyzer. The level of each of the electrical potentials of the DC conductors relative to ground depends on the type of AC grid and its grounding, as well as on the type of rectifier and on whether it has galvanic isolation or not.

It has been observed during the operation of electrolyzers that, over the course of operation, an increasing current flows from the electrolyzer to ground, i.e., that the insulation resistance of the electrolyzer decreases. For safety reasons, the operation of the electrolyzer must be interrupted if the insulation resistance falls below a predetermined threshold value or the ground current exceeds a corresponding threshold value, respectively. Therefore, it is desirable to counteract such a gradual decrease in insulation resistance while the electrolyzer is in operation, or to restore the insulation resistance to above the threshold value without the need for maintenance work, such as replacing parts of the electrolyzer.

### SUMMARY

A first and a second DC conductor are provided to supply an electrolyzer with electrical power. The electrical power can be transmissible from an AC grid (AC: alternating current/alternating voltage) to the DC conductors via a rectifier.

In a method for adjusting the potential level of the first and second DC conductors, in a first operating mode, the potential level of the first and second DC conductors is adjusted so that both DC conductors have the same polarity relative to ground potential.

A device for adjusting the potential level of the first and second DC conductors is configured to adjust, in a first operating mode, the potential level of the first and second DC conductors so that both DC conductors have the same polarity relative to ground potential.

The described adjusting makes it possible to specifically influence the potential level of the DC conductors. For example, the described adjusting can reduce so-called potential-induced degradation (PID) in electrolyzers, for example, in electrolyzers that have multiple electrolysis stacks. The PID effect can cause the insulation properties of the electrolyzer to be impaired by the migration of ions within the electrolyzer due to the potential difference of the DC conductors. By selectively influencing the potential level of the DC conductors, this ion migration can be reduced or reversed, and thus the PID effect can be reduced or reversed.

The potential of the DC conductors is set, for example, by the power electronics of the device such that the potential of both DC conductors has the same polarity relative to ground. This can, for example, reduce or avoid the PID effect.

In one embodiment of the method, the potential level in the first operating mode is adjusted in such a way as to effect regeneration of the electrolyzer. Depending on the design of the electrolyzer, it may be necessary for both DC conductors to have a positive or negative potential relative to ground in order to effect a regeneration. In one embodiment, the device adjusts the potential level with the corresponding polarity.

During the regeneration of the electrolyzer, the PID effect, for example, the unwanted migration of ions or a chemical reaction caused thereby, is at least partially reversed. For this purpose, the potential of the DC conductors is specifically chosen so that the reversal effect occurs. For example, the potentials of the DC conductors can be set as close together as possible with a absolute difference to ground potential less than a predefined value.

In one embodiment of the method and/or of the device, the first operating mode has a first sub-operating mode in which the potential difference between the first and second DC conductors is adjusted such that the voltage applied to the electrolyzer is below a threshold voltage. In this embodiment, the voltage applied to the electrolyzer is therefore below the threshold voltage, which, for example, can be selected with regard to the characteristic curve of the electrolyzer such that the electrolyzer operates within a specified one of its operating ranges.

The threshold voltage can here depend on the inception voltage of the electrolyzer and can correspond to the inception voltage. The inception voltage of the electrolyzer refers to the voltage at which the electrolysis process begins in the electrolyzer. The inception voltage can also be referred to as the decomposition voltage. The threshold voltage can, in one embodiment, lie in a range between 10% and 50% of the inception voltage. In this embodiment, the level of the potentials of the DC conductors is thus chosen such that the voltage applied to the electrolyzer is so small that the electrolyzer does not perform any electrolysis. The potential level can be adjusted in such a way that other desired processes can take place in the electrolyzer, e.g., the regeneration process, without any significant electrolysis occurring during this time and without the power required for this having to be provided.

In one embodiment of the method and/or of the device, the DC conductors are disconnected from the AC grid in the first sub-operating mode. This is advantageous if the AC grid has a fixed ground reference, as is the case for example with a TN grid. It can then be provided that the electrical power required for adjusting the potential level be obtained from sources other than the AC grid, e.g., from an auxiliary power supply that provides power with a potential level of the supply voltage that is independent of the potentials of the AC grid and, in particular, galvanically isolated from it. The auxiliary power supply can draw its electrical power, for example, from a battery and/or from an electric generator. However, the auxiliary power supply can also have a galvanically isolated connection to the AC grid, e.g., via a transformer, so that power consumption by the auxiliary power supply from the AC grid is still not excluded.

In one embodiment of the method and/or the device, the first operating mode has a second sub-operating mode. The first and second operating modes can be used alternately. In the second sub-operating mode of the first operating mode, the electrolyzer is supplied with electrical power from the AC grid via the rectifier to carry out an electrolysis process, wherein, in the second sub-operating mode, a potential difference between the first and second DC conductors is adjusted depending on the electrolysis process. This second sub-operating mode can be provided, in one embodiment, to supply the electrolyzer with electrical power from the AC grid to carry out the electrolysis. At the same time, the potential adjustment enables a reduction in the PID effect and/or a regeneration of the electrolyzer.

In embodiments, in the second sub-operating mode, the potential difference between the first and second DC conductors can depend on an operating voltage of the electrolyzer. In one embodiment, the potential difference can be adjusted so that a voltage is applied to the electrolyzer which corresponds to the operating voltage of the electrolyzer. In this embodiment, the level of the potentials of the DC conductors is thus chosen such that the voltage applied to the electrolyzer is large enough for the electrolyzer to carry out the electrolysis. The operating voltage of the electrolyzer is above the inception voltage and depends on, among other things, the type of the electrolyzer.

In embodiments of the method and/or the device, a second operating mode is provided in which the first or the second DC conductor is grounded, wherein the electrolyzer is supplied with electrical power from the AC grid via the rectifier to carry out the electrolysis process. In the second operating mode, the potential difference between the first and second DC conductors is adjusted depending on the electrolysis process. This second operating mode can be used, in one embodiment, to supply the electrolyzer with electrical power from the AC grid to carry out the electrolysis. In contrast to the first operating mode, in which the potentials of the two DC conductors are adjusted so that they have the same polarity relative to ground, i.e., both are on the same side of ground, in the second operating mode, it is also possible for the potentials of the two DC conductors to at times have different polarities, i.e., to be on different sides of ground.

In embodiments, in the second operating mode, the potential difference between the first and second DC conductors corresponds to the operating voltage of the electrolyzer. In this embodiment, the level of the potentials of the DC conductors is thus chosen such that the voltage applied to the electrolyzer is large enough for the electrolyzer to carry out the electrolysis.

In one embodiment of the method, the potential level is adjusted via the clocking of a semiconductor switch which is arranged between the first DC conductor and the ground potential or between the second DC conductor and the ground potential. The clocking can be done, for example, by the described device. By connecting one of the DC conductors to ground via the semiconductor switch, which can be clocked, a so-called soft, current-carrying connection of one of the DC conductors to ground is made possible. The current can be controlled via the clocking, and in this way the potential level can be adjusted. Using the semiconductor switch, a so-called “soft grounding” can thus be realized.

In one embodiment of the method, a ground current flowing through the semiconductor switch is monitored. The ground current is the current that flows between the DC conductor to which the semiconductor switch is connected and ground. The monitoring is done, for example, via the described device. The monitoring can be carried out, in one embodiment, by detecting the ground current using a current meter A, wherein the current meter A can be arranged in the device. In a computing unit or circuit of the device, the magnitude of the ground current can then be determined and a reaction can be triggered if the ground current becomes too large. This allows for the implementation of a grounding protection design that can react to supercritical ground currents and therefore to ground faults.

The potential of each of the two DC conductors can be a specified minimum distance from ground potential. It can be provided that this minimum distance be maintained in each of the described operating modes. The minimum distance is set, in one embodiment, by adjusting the potential levels. Maintaining the minimum distance ensures that regeneration progress is achieved within a specified time frame, or that degeneration is counteracted to a sufficient degree.

A DC grid comprises the electrolyzer, the described device, and the first and second DC conductors. Optionally, the DC grid comprises an auxiliary power supply for providing the device with electrical power as needed. A need to supply the device with electrical power can be present, for example, if the DC grid is separated from the AC grid and no electrical power can be drawn from the AC grid. The need for electrical power to adjust the potential level can then be covered, for example, by the auxiliary power supply.

### BRIEF DESCRIPTION OF THE DRAWINGS

The following section provides further explanation and description of embodiments of this application with reference to the figures, in which:

FIG. 1 schematically shows a DC grid with a device for adjusting the potential level,

FIG. 2 schematically shows a first embodiment of a potential level of DC conductors with an ground current profile,

FIG. 3 schematically shows a second embodiment of a potential level of DC conductors,

FIG. 4 schematically shows a third embodiment of a potential level of DC conductors,

FIG. 5 schematically shows a fourth embodiment of a potential level of DC conductors,

FIG. 6 schematically shows a fifth embodiment of a potential level of DC conductors.

The same reference signs are used in the figures for identical or similar elements. Representations in the figures may not be to scale.

### DETAILED DESCRIPTION

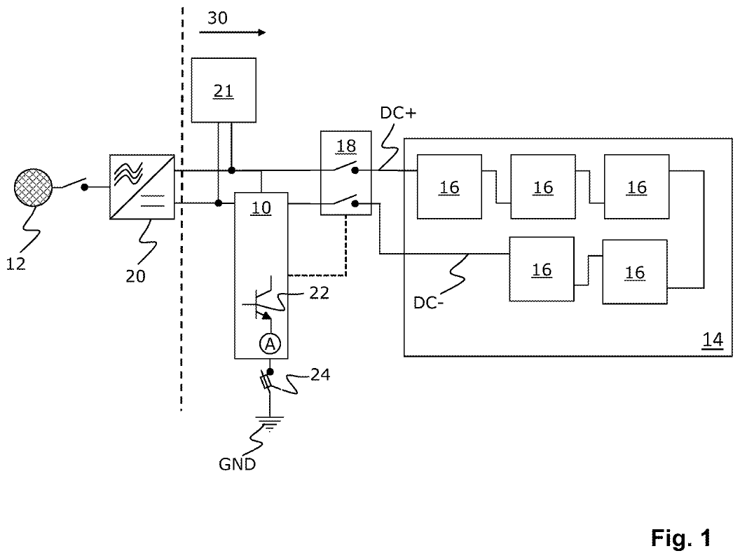

FIG. 1 schematically shows a device 10 for adjusting the potential level of a first DC conductor DC+ and a second DC conductor DC−. Via a rectifier 20, electrical AC power from an AC grid 12 can be converted into electrical DC power and transmitted to the DC conductors DC+, DC−.

A DC grid 30 comprises the device 10, the DC conductors DC+, DC−, the DC switch 18, a fuse 24 and an electrolyzer 14. The electrolyzer 14 comprises a plurality of so-called electrolysis stacks 16 connected in series. Each electrolysis stack 16 comprises at least one electrolysis cell in which the desired electrolysis process takes place. The electrolysis can, for example, be the electrolysis of water to produce hydrogen and oxygen. Via the DC conductors DC+, DC−, the electrolyzer 14 is supplied with electrical DC power which is drawn from the AC grid 12 via the rectifier 20. The AC grid 12 can, for example, be a public supply grid. The AC grid 12 can be single-phase or multi-phase. The AC grid 12 can be grounded or ungrounded.

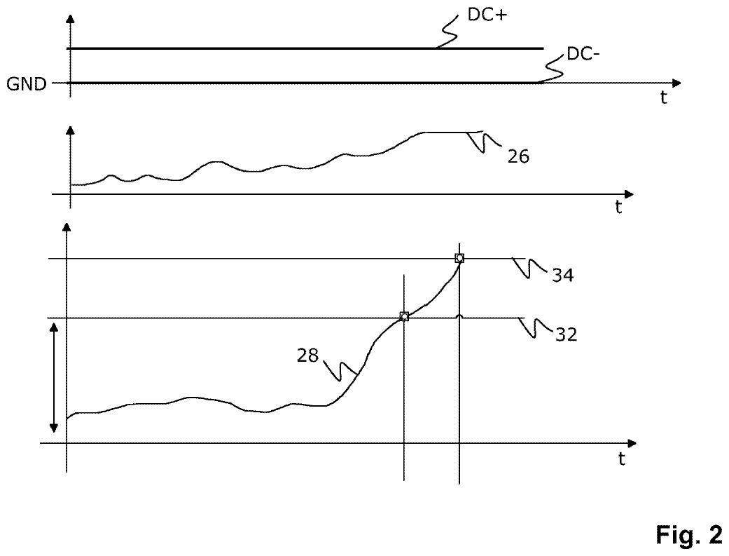

In a first operating mode, the device 10 adjusts the potential level of the two DC conductors DC+, DC− such that both have the same polarity relative to ground potential GND. The device is therefore designed to carry out a method which, in a first operating mode, adjusts the potential level of the two DC conductors DC+, DC− such that both have the same polarity relative to ground potential GND. For this purpose, the device 10 has a semiconductor switch 22 which is clocked by the device 10. The semiconductor switch 22 establishes a connection between either the first DC conductor DC+ or the second DC conductor DC− and ground potential GND. This connection is clocked, i.e., the semiconductor switch 22 is opened and closed according to a duty cycle 26 (see FIG. 2) so that the flowing current can be adjusted by the duty cycle 26 of the clocking. The clocking of the semiconductor switch 22 can be carried out in such a way that the potential level of the two DC conductors DC+, DC− to each other and in relation to ground potential GND can be specifically adjusted.

At the same time, the flowing current is optionally detected via a current meter A. Via the current meter A, the device 10 can detect the current flowing through the semiconductor switch 22 and, if necessary, for example, open the DC switches 18 in order to separate the electrolyzer 14 from the rectifier 20. The DC grid 30 is additionally protected against excessively large ground currents by the fuse 24.

A second operating mode is carried out as an alternative to the first operating mode. The operation of the DC grid 30 can switch between the first operating mode and the second operating mode. In the second operating mode, the potentials of the first and second DC conductors DC+, DC− are adjusted such that the electrolysis process can be carried out in the electrolyzer 14. Thus, electrical power from the AC grid 12 is transferred to the electrolyzer 14 via the DC conductors DC+, DC− to carry out the electrolysis. The voltage applied to the electrolyzer 14, which corresponds to the potential difference between the first DC conductor DC+ and the second DC conductor DC−, is greater than an inception voltage of the electrolyzer 14 and corresponds, for example, to an operating voltage of the electrolyzer 14.

If the DC grid 30 with the electrolyzer 14 is operated on an AC grid 12 which is designed as a TN grid, then, in the second operating mode, the voltage of the first DC conductor DC+ and of the second DC conductor DC− is symmetrical to ground potential GND, if the DC grid 30 is connected via the rectifier 20 to the AC grid 12 which is designed as a TN grid—for example, as a neutral-grounded AC grid 12. As a result, the second DC conductor has a negative voltage relative to ground GND. This negative voltage can cause negatively charged ions to flow towards ground, thereby degrading the electrolyzer 14 due to a PID effect and possibly greatly reducing its service life. If, as shown in FIG. 1, a plurality of electrolysis stacks 16 are connected in series to form a string, this effect can be significantly amplified.

Even if the electrolyzer 14 is connected via a rectifier to a galvanically isolated AC grid 12, e.g., an IT grid, a PID effect can be observed. Here too, in the second operating mode, a voltage can occur between the two DC conductors DC+, DC− if their potential is symmetrical or approximately symmetrical relative to ground potential GND. The PID effect can therefore occur in various types of AC grids 12, TN grids or IT grids.

The described device 10 and the described method offer the advantage that, in the first operating mode, such a PID effect can be reduced, diminished or even reversed.

FIG. 2 shows an example of another embodiment for the potential level of the first DC conductor DC+ and the second DC conductor DC− in the second operating mode. In one embodiment, the second operating mode can be used alternately with the first operating mode. The following describes how the method and the device 10 can function as ground current monitoring in the second operating mode.

In this embodiment, the DC grid 30 is supplied via the rectifier 20 from a galvanically isolated AC grid 12—for example, an IT grid. One of the DC conductors, in the example shown, the second DC conductor DC−, is grounded. The first DC conductor is adjusted to a potential level such that the voltage between the conductors is large enough to operate the electrolysis in the electrolyzer 14.

By grounding one of the DC conductors, in this case the second DC conductor DC−, the PID effect can be reduced or avoided. Which of the two DC conductors DC+, DC− is grounded can depend, for example, on the type of rectifier 20 used.

The middle graph of FIG. 2 shows a possible course of the duty cycle 26 of the clocking of the semiconductor switch 22. The lower graph of FIG. 2 shows a possible course of the ground current 28.

By means of the method and device for adjusting the potential level, the potential level is set by clocking the semiconductor switch 22, as shown in the upper graph of FIG. 2. In order to maintain the potential level, the clocking must be adapted over time, e.g., due to a fault, and the ground current 28 increases, e.g., due to the fault. When the ground current 28 reaches the first threshold 32, the clocking is stopped and, for example, the electrolyzer 14 is disconnected from the rectifier 20 by opening the DC switches 18. If the ground current 28 continues to rise, e.g., due to the severity of the fault, the fuse 24 will trip—for example, when the threshold 34 is reached.

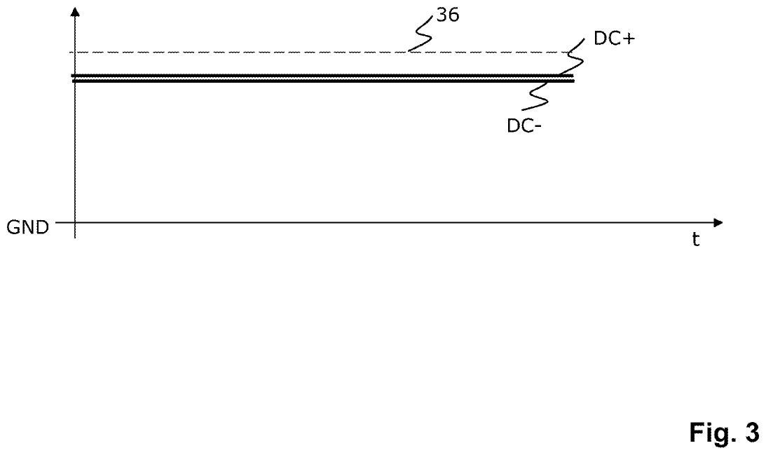

FIG. 3 shows a first embodiment of a first sub-operating mode of the first operating mode. The ground potential GND and the potential corresponding to a maximum DC voltage 36 for the DC grid 30 are shown.

The potential of the first DC conductor DC+ and the second DC conductor DC− are adjusted by the device 10 such that they are both positive relative to the ground potential GND. That is, they both have a positive polarity relative to ground potential GND.

The potential difference between the first DC conductor DC+ and the second DC conductor DC− is adjusted such that the voltage applied to the electrolyzer 14 is below a threshold voltage. The threshold voltage is below an inception voltage of the electrolyzer 14, so that no electrolysis takes place in the electrolyzer 14 in the first sub-operating mode. The threshold voltage can, for example, lie in a range between 10% and 50% of the inception voltage.

Since no electrolysis takes place in the electrolyzer 14 in the first sub-operating mode, the DC conductors DC+, DC− of the DC grid 30 can be disconnected from the AC grid 12 in the first sub-operating mode according to one embodiment. This also makes it possible to carry out the first sub-operating mode regardless of the type of AC grid 12. The first sub-operating mode is therefore possible for various types of AC grid 12—for example, a TN grid or an IT grid.

If the DC grid 30 is disconnected from the AC grid in the first sub-operating mode, the electrical power used to adjust the potential level can be drawn from an auxiliary power supply 21 of the DC grid 30.

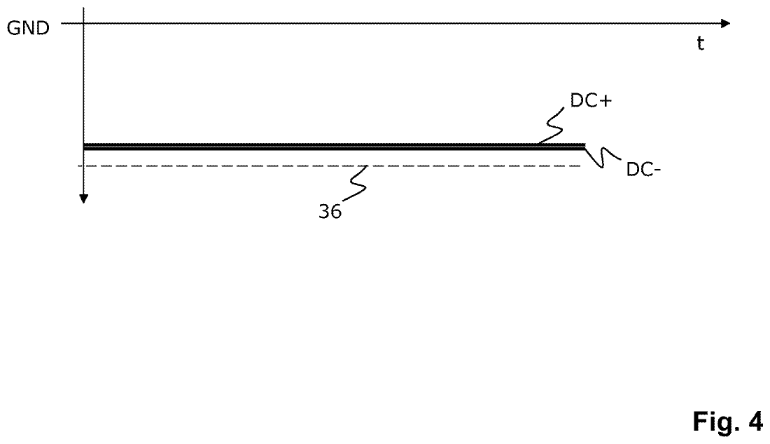

FIG. 4 shows a second embodiment of the first sub-operating mode of the first operating mode.

In this embodiment, the potential of the first DC conductor DC+ and of the second DC conductor DC− are adjusted by the device 10 such that they are both negative relative to the ground potential GND. That is, they both have a negative polarity relative to ground GND.

The potential difference between the first DC conductor DC+ and the second DC conductor DC− is adjusted such that the voltage applied to the electrolyzer 14 is below the threshold voltage. The threshold voltage is below an inception voltage of the electrolyzer 14, so that no electrolysis takes place in the electrolyzer 14 in the first sub-operating mode. The threshold voltage can, for example, lie in a range between 10% and 50% of the inception voltage.

Since no electrolysis takes place in the electrolyzer 14 in the first sub-operating mode, the DC conductors DC+, DC− of the DC grid 30 can also be disconnected from the AC grid 12 in the first sub-operating mode. This also makes it possible to carry out the first sub-operating mode regardless of the type of AC grid 12. The first sub-operating mode is therefore possible for various types of AC grid 12—for example, a TN grid or an IT grid.

If the DC grid 30 is disconnected from the AC grid in the first sub-operating mode, the electrical power used to adjust the potential level can be drawn from an auxiliary power supply 21 of the DC grid 30.

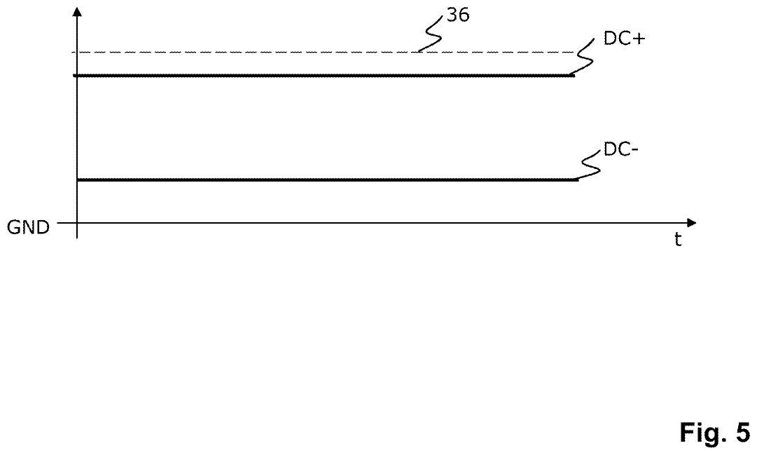

FIG. 5 shows a first embodiment of the second sub-operating mode of the first operating mode. In the second sub-operating mode, the electrolyzer 14 is supplied with electrical power from the AC grid 12 via the rectifier 20 to carry out the electrolysis process in the electrolyzer 14.

The potential of the first DC conductor DC+ and the second DC conductor DC− are adjusted by the device 10 such that they are both positive relative to the ground potential GND. That is, they both have a positive polarity relative to ground potential GND.

The potential difference between the first DC conductor DC+ and the second DC conductor DC− in the second sub-operating mode is adjusted such that, in the second sub-operating mode, the potential difference between the first DC conductor DC+ and the second DC conductor DC− corresponds to an operating voltage of the electrolyzer 14. At least, the potential difference between the first DC conductor DC+ and the second DC conductor DC− corresponds to the operating voltage of the electrolyzer 14 approximately and in such a way that the electrolysis process can take place in the electrolyzer 14.

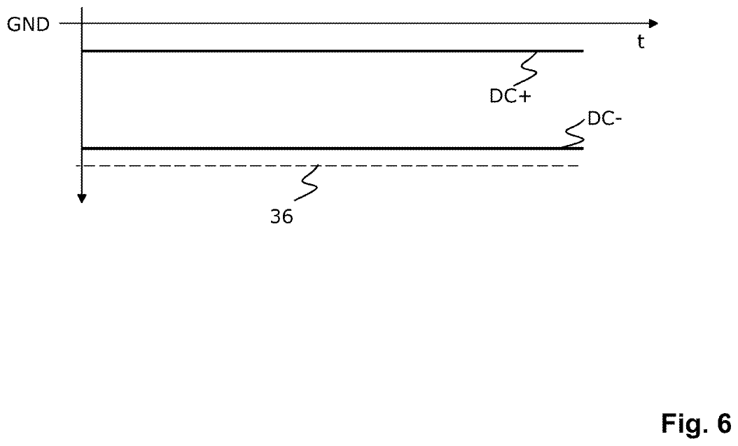

FIG. 6 shows a second embodiment of the second sub-operating mode of the first operating mode. In the second sub-operating mode, the electrolyzer 14 is supplied with electrical power from the AC grid 12 via the rectifier 20 to carry out the electrolysis process in the electrolyzer 14.

The potential of the first DC conductor DC+ and of the second DC conductor DC− are adjusted by the device 10 such that they are both negative relative to the ground potential GND. That is, they both have a negative polarity relative to ground potential GND.

The potential difference between the first DC conductor DC+ and the second DC conductor DC− in the second sub-operating mode is adjusted such that, in the second sub-operating mode, the potential difference between the first DC conductor DC+ and the second DC conductor DC− corresponds to an operating voltage of the electrolyzer 14. At least, the potential difference between the first DC conductor DC+ and the second DC conductor DC− corresponds to the operating voltage of the electrolyzer 14 approximately and in such a way that the electrolysis process can take place in the electrolyzer 14.

What is claimed is:

1. A method for adjusting a potential level of a first DC conductor or a second DC conductor, or both, wherein the first DC conductor and the second DC conductor are provided to supply an electrolyzer with electrical power and the electrical power is configured to be transmitted via a rectifier from an AC grid to the first DC conductor and the second DC conductor, wherein, in a first operating mode, the potential level of the first DC conductor or the second DC conductor, or both, is adjusted such that both the first DC conductor and the second DC conductor have a same polarity relative to a ground potential.

2. The method according to claim 1, wherein the potential level in the first operating mode is adjusted such that both the first DC conductor and the second DC conductor have a positive polarity relative to ground potential.

3. The method according to claim 1, wherein the potential level in the first operating mode is adjusted such that both the first DC conductor and the second DC conductor have a negative polarity relative to ground potential.

4. The method according to claim 1, wherein the first operating mode has a first sub-operating mode in which a potential difference between the first DC conductor and the second DC conductor is adjusted such that a voltage applied to the electrolyzer is below a threshold voltage.

5. The method according to claim 4, wherein the threshold voltage depends on an inception voltage of the electrolyzer, and wherein the threshold voltage is in a range between 10% and 50% of the inception voltage.

6. The method according to claim 4, wherein the first DC conductor and the second DC conductor are disconnected from the AC grid in the first sub-operating mode.

7. The method according to claim 4, wherein the electrical power used to adjust the potential level is obtained from an auxiliary power supply.

8. The method according to claim 1, wherein the first operating mode has a second sub-operating mode in which the electrolyzer is configured to be supplied with electrical power from the AC grid via the rectifier to carry out an electrolysis process, wherein, in the second sub-operating mode, a potential difference between the first DC conductor and the second DC conductor is adjusted depending on the electrolysis process.

9. The method according to claim 8, wherein, in the second sub-operating mode, the potential difference between the first DC conductor and the second DC conductor depends on an operating voltage of the electrolyzer.

10. The method according to claim 1, wherein a second operating mode is provided in which the first DC conductor or the second DC conductor is grounded, wherein the electrolyzer is configured to be supplied with electrical power from the AC grid via the rectifier to carry out an electrolysis process, and wherein, in the second operating mode, a potential difference between the first DC conductor and the second DC conductor is adjusted depending on the electrolysis process.

11. The method according to claim 1, wherein the potential level is adjusted via a clocking of a semiconductor switch which is arranged between the first DC conductor and a ground potential or between the second DC conductor and the ground potential.

12. The method according to claim 11, wherein a ground current flowing through the semiconductor switch is monitored.

13. The method according to claim 1, wherein an absolute value of the potential level of each of the first DC conductor and the second DC conductor relative to the ground potential is below a predefined value.

14. A device for adjusting a potential level of a first DC conductor and a second DC conductor, wherein the first DC conductor and the second DC conductor are provided to supply an electrolyzer with electrical power and the electrical power is configured to be transmitted via a rectifier from an AC grid to the first DC conductor and the second DC conductor, wherein the device is configured, in a first operating mode, to adjust the potential level of the first DC conductor or the second DC conductor, or both, such that both the first DC conductor and the second DC conductor have the same polarity relative to ground potential.

15. The device according to claim 14, wherein the device is configured to adjust the potential level in the first operating mode such that both the first DC conductor and the second DC conductor have a positive polarity relative to ground potential.

16. The device according to claim 14, wherein the device is configured to adjust the potential level in the first operating mode such that both the first DC conductor and the second DC conductor have a negative polarity relative to a ground potential.

17. The device according to claim 14, wherein the device is configured to clock a semiconductor switch to adjust the potential level, wherein the semiconductor switch is arranged between the first DC conductor and the ground potential or between the second DC conductor and the ground potential.

18. The device according to claim 17, wherein the device is configured to monitor a ground current flowing through the semiconductor switch.

19. A DC grid comprising an electrolyzer, a device according to claim 14, and the first DC conductor and the second DC conductor.

20. The DC grid according to claim 19, further comprising an auxiliary power supply configured to supply the device with electrical power as required.
